(19) United States
(12) Patent Application Publication
(10) Pub. No.: US 2017/0299062 A1
(43) Pub. Date: Oct. 19, 2017

(54) SEALING DEVICE FOR SEAL RUNNER FACE

(71) Applicant: PRATT & WHITNEY CANADA CORP., Longueuil (CA)

(72) Inventor: Daniel BLAIS, St-Jean-sur-Richelieu (CA)

(21) Appl. No.: 15/131,597

(22) Filed: Apr. 18, 2016

(51) Int. Cl. F16J 15/3268; F01D 11/00

(52) U.S. Cl. CPC F16J 15/3268; F01D 11/003; F05D 2240/55; F05D 2220/32

(57) ABSTRACT

A sealing device comprises an annular receptacle defining an annular axial opening. A first annular seal and a second annular seal are radially superposed in the annular receptacle, the first annular seal and the second annular seal being independently movable in a generally axial direction and configured to project out of the annular axial opening of the annular receptacle to sealingly contact a common radial face rotating with a shaft. Biasing devices are provided for the first annular seal and the second annular seal, the at least one biasing device configured to bias the annular seals independently from one another against the common radial face. The sealing device may be used in a gas turbine engine. A method for sealing a space between a radial face of a seal runner portion of a shaft and a structure is also provided.

### TECHNICAL FIELD

The application relates generally to seals of the type used to seal a rotating shaft and, more particularly, to such seals used to seal a rotating axial face.

### BACKGROUND OF THE ART

Face seals are commonly used to seal an annular passage between a shaft and a structure. The face seals are often required to preserve oil on one side of the shaft. In such face seals, a seal fixed in rotation rubs and wears against a face of a shaft component, such as a rotating seal runner. The surface of contact between the seal and the seal runner is a dynamic seal surface. One difficulty is that seal runner faces are not always substantially radially planar, for instance due to thermal gradients. Therefore, an axial deviation from a radial plane may lead to a gap between the seal and the seal runner, which may cause a fluid leak.

### SUMMARY

In one aspect, there is provided a sealing device comprising: an annular receptacle defining an annular axial opening; a first annular seal and a second annular seal radially superposed in the annular receptacle, the first annular seal and the second annular seal being independently movable in a generally axial direction and configured to project out of the annular axial opening of the annular receptacle to sealingly contact a common radial face rotating with a shaft; and at least one biasing device for the first annular seal and the second annular seal, the at least one biasing device configured to bias the annular seals independently from one another against the common radial face.

In a second aspect, there is provided a gas turbine engine comprising: a structure; at least one rotating shaft having a radial face on a seal runner portion thereof, an annular space being defined between the structure and the at least one rotating shaft; and a sealing device comprising an annular receptacle secured to the structure to block the annular space, the annular receptacle defining an annular axial opening, a first annular seal and a second annular seal radially superposed in the annular receptacle, the first annular seal and the second annular seal being independently movable in a generally axial direction and configured to project from the annular axial opening to sealingly and commonly contact the radial face, and at least one biasing device for the first annular seal and the second annular seal, the at least one biasing device biasing the annular seals independently from one another against the common radial face.

In a third aspect, there is provided a method for sealing a space between a radial face of a seal runner portion of a shaft and a structure, comprising: radially superposing a first and a second annular seal in an annular receptacle located in the space; biasing the first annular seal against the radial face of the seal runner portion; and biasing the second annular seal against the radial face of the seal runner portion, the biasing of the first annular seal and the second annular seal being independent from one another.

Further details of these and other aspects of the present invention will be apparent from the detailed description and figures included below.

### DESCRIPTION OF THE DRAWINGS

Reference is now made to the accompanying figures, in which:

FIG. 1 is a schematic cross-sectional view of a turbofan gas turbine engine;

FIG. 2 is a cross-section view of a sealing device in accordance with the present disclosure;

FIG. 3 is an enlarged cross-section view of the sealing device of FIG. 2;

FIG. 4 is a perspective view of annular seals and stopper of the sealing device of FIG. 2;

FIG. 5 is a perspective view of the annular seals of FIG. 4; and

FIG. 6 is a perspective view of the assembly of FIG. 4, from a different standpoint.

### DETAILED DESCRIPTION OF THE PREFERRED EMBODIMENTS

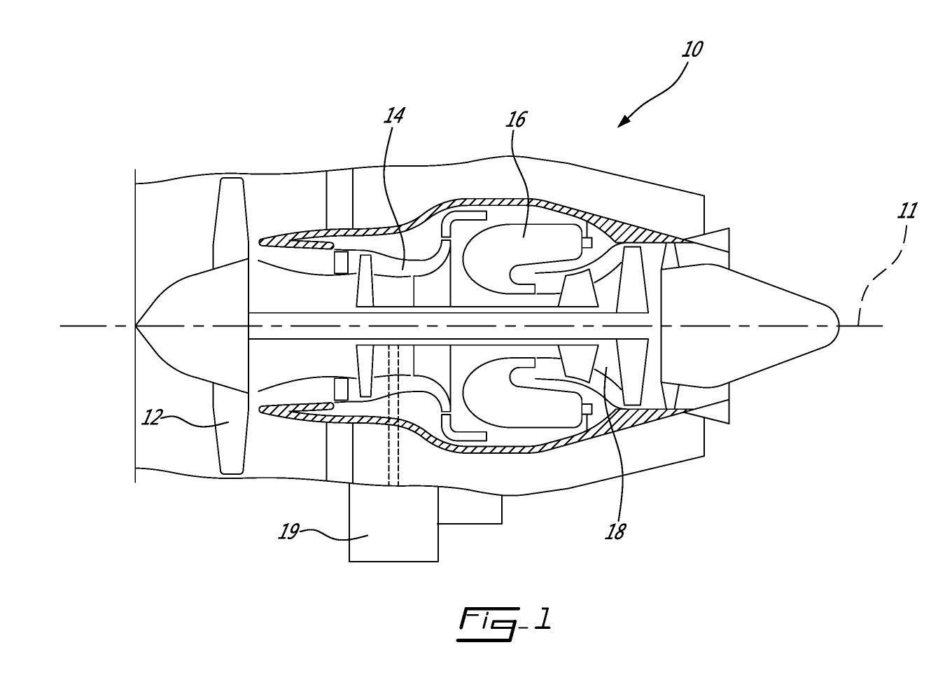

FIG. 1 illustrates a turbofan gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. An accessory gearbox 19 may be driven by either one of the compressor 14 and the turbine section 18.

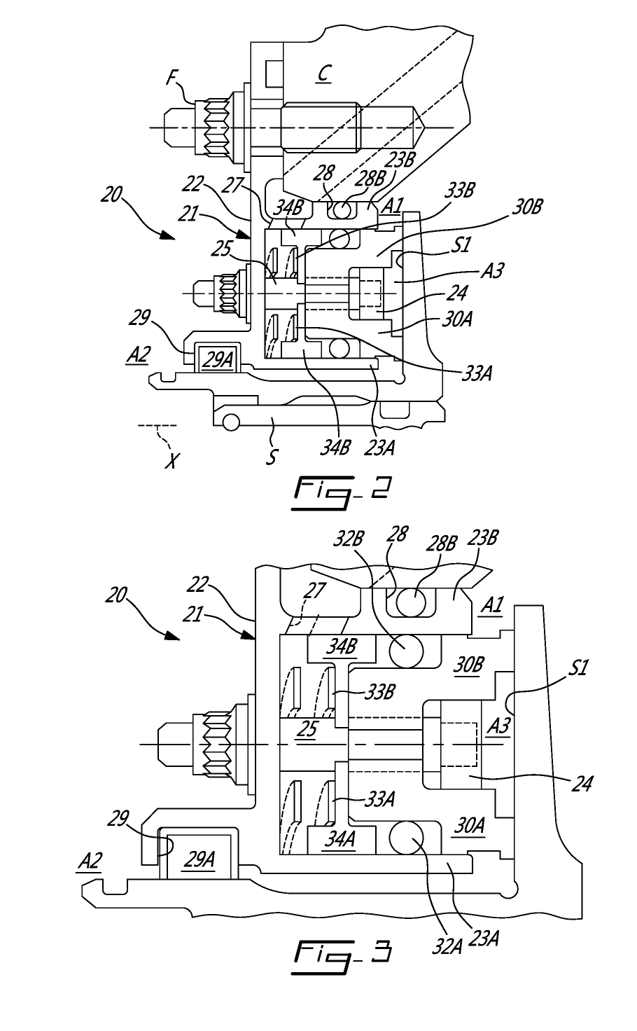

Referring to FIG. 2, a sealing device in accordance with the present disclosure is generally shown at 20, for instance of the type used to seal a space between a shaft S and a structural component C (i.e., a support structure of the apparatus using the sealing device 20, a housing thereof, etc) of the gas turbine engine 10, to block fluid passage through the space, such as oil commonly found in location A1, which oil may be cooling oil, etc. The sealing device 20 is used to limit or prevent oil from reaching location A2. As illustrated in FIGS. 2 and 3, the shaft S may have a seal runner portion having a face S1 that extends radially, with respect to the rotation axis X of the shaft S. The seal runner portion may or may not be integral with the shaft S. The shaft S may for example be a propeller shaft supporting the fan 12 (FIG. 1). The sealing device 20 can be used as an output shaft seal on a turboshaft and turboprop engines, as well as a bearing cavity seal on engine mainshafts. It is also contemplated to use the sealing device 20 in other applications as well.

The sealing device 20 has an annular receptacle 21 that may serve as the structure of the sealing device 20. The annular receptacle 21 may therefore be fixed to the structural component C via a face wall 22, and any appropriate fastener such as bolts F. The connection of the annular receptacle 21 by way of the face wall 22 is one of numerous possible connection arrangements, the connection arrangement being designed as a function of the structure surrounding the shaft S. For example, the annular receptacle 21 could be lodged into a cylindrical passage surrounding the shaft S, may be held axially by lock rings, etc.

Tubular walls 23A and 23B project in an axial direction from the face wall 22. The tubular walls 23A and 23B, referred to concurrently as the tubular walls 23, extend toward the face S1 of the seal runner, with their ends are spaced from the face S1. Therefore, the face wall 22 and the tubular walls 23 jointly define an annular cavity of the sealing device 20, which annular cavity has an annular axial opening at the end of the tubular walls 23.

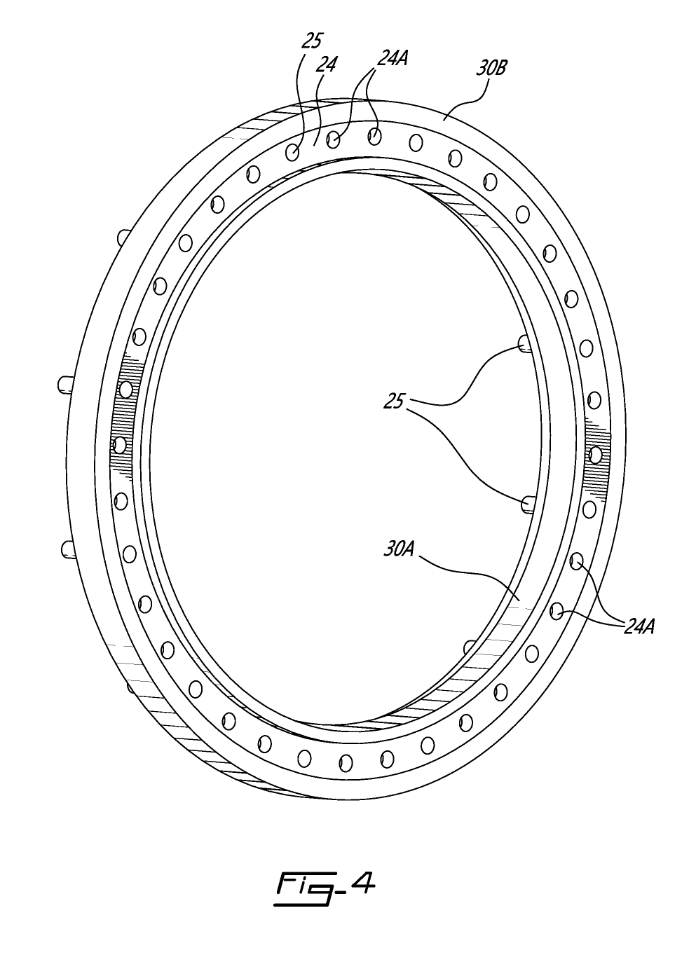

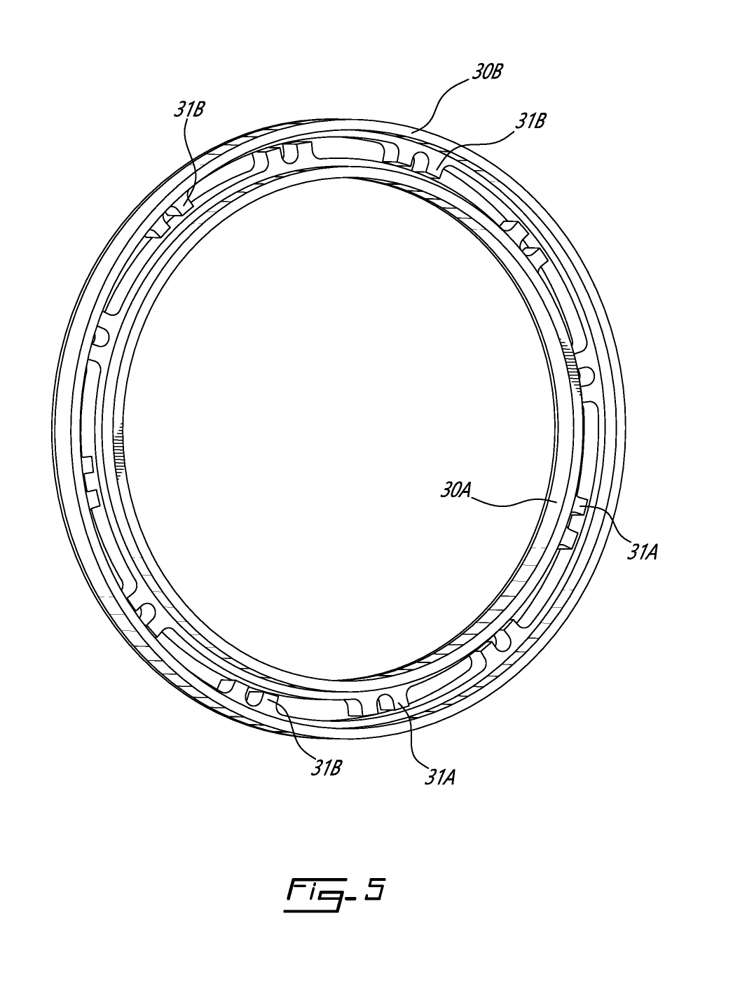

An annular stopper 24 may be located near or at the annular axial opening. The annular stopper 24 may be generally centrally located between the tubular walls 23. As observed in FIG. 4, the annular stopper 24 may have holes 24A. Pins 25 connected to the face wall 22 may support the annular stopper 24, via the holes 24A. The pins 25 are axial members that may be circumferentially distributed in the annular receptacle 21, as illustrated in FIG. 6, connected in any appropriate way to the annular stopper 24, for instance by being brazed to it. The pins 25 may also serve as sliding guides for annular seals, as described herein after. As shown in FIG. 6, the pins 25 may have enlarged sleeve portions 26 to be used as sliding guides. The pins 25 are one of numerous possible fastening arrangements for the annular stopper 24, if the annular stopper 24 is present in the sealing device 20. As shown in FIG. 4, the number of holes 24A may exceed the number of pins 25 (although it may also be the same), the holes 24A defining air passages through the annular stopper 24.

The annular receptacle 21 may also have a fluid inlet 27, in fluid communication with the annular cavity, for injection of pressurized fluid, such as air to be used as buffer air. Channels 28 and 29 may also be provided, to accommodate seals 28B and 29A. The seal 28B may be an O-ring, a gasket, etc, made of a material capable of withstanding the pressures and temperatures in the apparatus. Moreover, the material must be resistant to the nature of ambient fluids (e.g., oil). The seal 29A may be used to block debris or solids from penetrating the space between the seal runner of the shaft S and the sealing device 20. For instance, seal 29A may be a felt strip, or the like.

The sealing device 20 has movable components, illustrated in the 30s. The sealing device 20 has a pair of annular seals, concurrently referred to as annular seals 30 but illustrated as 30A and 30B. The annular seals 30 are radially superposed in the annular receptacle 21, and project from the annular axial opening to sealingly contact the face S1. By being radially superposed, the annular seals 30 have different radii, the annular seal 30B shown as having a greater radius than the annular seal 30A. The radially superposed relation may entail having both the annular seals 30 at the same axial position along axis X, and may further entail having both seals 30 concentric about a same axis, i.e., axis X. However, some axial or central offset is possible. The annular seals 30 are made of a material that will wear off gradually, while forming a contact surface conforming to the face S1 they will rub against, to create a dynamic seal interface. For example, the annular seals 30 are made of carbon, or equivalent. The annular seals 30 may differ from one another in terms of material. For example, different grades of carbon may be used.

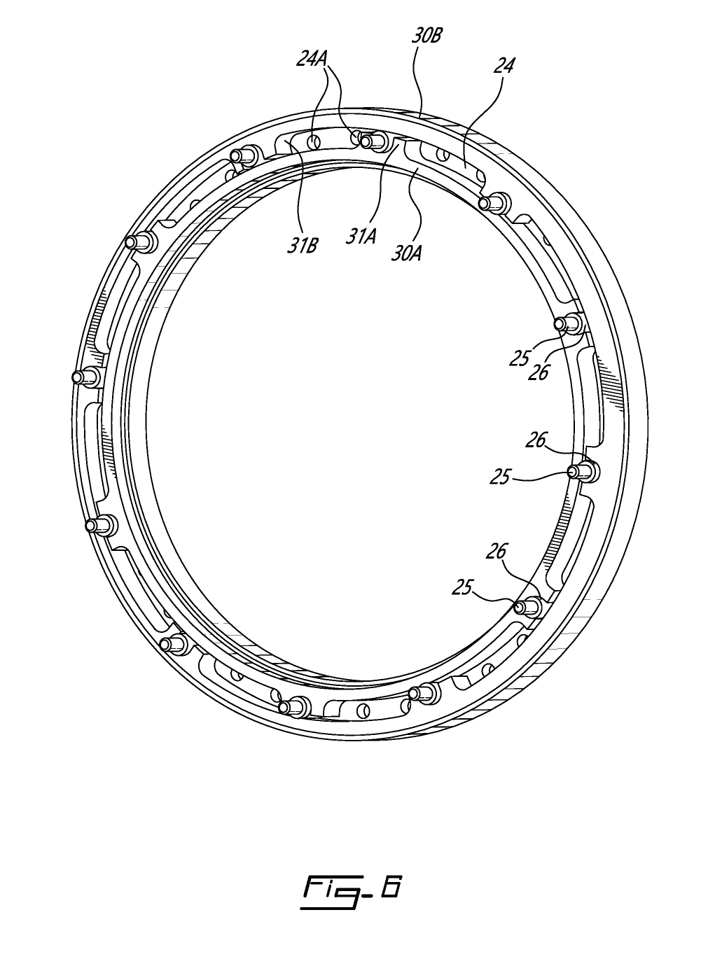

The seals 30 are displaceable along axis X. For this purpose, the annular seals 30 may have brackets 31, shown as 31A and 31B in FIGS. 5 and 6. The brackets 31 may be circumferentially distributed on the seals 30, and have a U shaped cavity for complementary sliding engagement with the pins 25. An alternative to brackets 31 could be throughbores in the seals 30. As the pins 25 are between the seal 30A and the seal 30B, the seal 30A has its brackets 31A facing radially outwardly, whereas the seal 30B has its brackets 31B oriented radially inwardly. The cooperation between the pins 25 and the brackets 31 blocks the seals 30 from rotating in spite of being in contact with the rotating shaft S. A single bracket 31 per seal 30 could suffice, but a circumferential distribution of the brackets 31 may limit the play between the seals 30 and the annular receptacle 21 and constrain the seals 30 to strict axial movement along a direction parallel to axis X.

The annular seals 30A and 30B have a stepped cross-sectional shape, to make space for the annular stopper 24 located between them, and to be in sealing contact with the tubular walls 23A and 23B with a nose portion thereof, respectively, and therefore limit fluid leakage therethrough. The stepped cross-section shape results in the presence of radial surfaces coming into contact with the annual stopper 24 to concurrently delimit the movement of the seals 30A and 30B in the axial direction.

It is also considered to use additional annular seals 32A and 32B, respectively, to assist in sealing the space between the annular seals 30, and the respective tubular walls 23. The seals 32 may be O-rings, gaskets, etc, made of a material capable of withstanding the pressures and temperatures in the apparatus. Moreover, the material must be resistant to the nature of ambient fluids (e.g., oil). According to another configuration, the inner surface of the annular seal 30A may be substantially cylindrical, whereas the outer surface of the annular seal 30B may be substantially cylindrical, for example with annular channels machined therein to receive the seals 32. Other configurations are also considered.

Referring to FIGS. 2 and 3, biasing devices 33A and 33B, concurrently referred to as 33, are provided for each of the annular seals 30. The biasing devices 33 bias the annular seals 30 independently from one another against the seal runner face S1. Stated differently, the independence of the biasing devices 33A and 33B may cause movement of one of the annular seals 30, while the other of the annular seals 30 does not move. If the face S1 is not perfectly radial, the annular seals 30 will adapt to axial deviations by the biasing action of the biasing devices 33A and 33B, independently, with two annular contact surfaces adapting independently to axial deviation. The biasing devices 33 may take various forms, such as a coil spring, wave spring, wave spring washer, inflatable bellow, to name a few of numerous possibilities. Moreover, although a pair of biasing devices 33 is shown, a single biasing device could be shared by the annular seals 30, provided the movement of each of the seals 30 is independent. The biasing devices 33 may abut against the face wall 22, and be in direct contact with the seals 30. Alternatively, interface rings 34 (a.k.a., washers), illustrated as 34A and 34B, may interface the biasing devices 33 to the annular seals 30. The interface rings 34 may define a shoulder to ensure the proper alignment of the biasing device 33, and may also protect the seals 32. The biasing rate (a.k.a., the spring constant) may be different between the biasing devices 33A and 33B. For example, the axial deviation of the radial face S1 may be greater further to the axis X, whereby the biasing device 33B may have a greater biasing rate.

In the illustrated embodiment, a sealed chamber is defined by the combination of annular cavity of the annular receptacle 21, the annular stopper 24 and the annular seals 30. As shown in FIG. 2, this sealed chamber is connected to a source of cooling fluid, via the fluid inlet 27, and for example a conduit defined in the structural component C. The feeding conduit may be machined or fabricated directly in the structural component C. Alternatively, the feeding conduit may be separate tubes, pipes and/or conduits extending to the fluid inlet 27.

With this arrangement, pressurized fluid, such as buffer air, may be fed to the sealed chamber and therefore pressurize it, and assist in biasing the seals 30 toward the face S1. This buffer air may absorb heat from the annular seals 30. According to an embodiment, the pressure in the sealed chamber is greater than the exterior environment of the shaft S to induce a flow of the pressurized fluid from the sealed cavity to the surroundings, instead of oil leaking through the sealing device 20. As shown in FIG. 4, some free holes 24A in the stopper 24 may serve as air passage, for air to reach the volume A3 between the seals 30. The air pressure may be controlled to be greater in volume A3 than the ambient pressure in A1 or in A2, such that any periodic or temporary spacing between either seal 30 and the face S1 would cause air to escape to A1 or A2, and serve as lubricant between the seals 30 and the face S1, and hence assisting in excluding oil from passing. The air pressure may be controlled to cause the punctual separation of one or both of the seals 30 from the face S1 to lubricate the noses of the seals 30.

In operation, a method for sealing the space between the radial face S1 of a seal runner portion of the shaft S and the structure C comprises radially superposing the annular seals 30A and 30B in the annular receptacle 21 located in the space. The first annular seal 30A is biased against the radial face S1 of the seal runner portion. The second annular seal 30B is also biased against the radial face S1 of the seal runner portion, the biasing of the first annular seal 30A and the second annular seal 30B being independent from one another. The independence may be achieved by biasing the first annular seal 30A a first spring 33A, and biasing the second annular seal 30B with a second spring 33B. A sealed chamber may be formed between the annular seals 30, the annular receptacle 21 and the radial face S1 of the seal runner portion, pressurized air being injected in the sealed chamber. Injecting the pressurized air may include leaking the pressurized air between one or both of the annular seals 30 and the radial face S1 of the seal runner portion.

The above description is meant to be exemplary only, and one skilled in the art will recognize that changes may be made to the embodiments described without departing from the scope of the invention disclosed. For example, due to the above-described arrangements, a single jet of cooling oil may suffice to cool the seal runner. The seals 30 move in a generally axial position, in that there may be a slight radial component to the movement. Still other modifications which fall within the scope of the present invention will be apparent to those skilled in the art, in light of a review of this disclosure, and such modifications are intended to fall within the appended claims. The above description is meant to be exemplary only, and one skilled in the art will recognize that changes may be made to the embodiments described without departing from the scope of the invention disclosed.

What is claimed is:

1. A sealing device comprising:
an annular receptacle defining an annular axial opening;
a first annular seal and a second annular seal radially superposed in the annular receptacle, the first annular seal and the second annular seal being independently movable in a generally axial direction and configured to project out of the annular axial opening of the annular receptacle to sealingly contact a common radial face rotating with a shaft; and
at least one biasing device for the first annular seal and the second annular seal, the at least one biasing device configured to bias the annular seals independently from one another against the common radial face.

2. The sealing device according to claim 1, wherein the biasing device includes a spring for each said annular seal, the springs being accommodated in the annular receptacle.

3. The sealing device according to claim 2, wherein a biasing rate of the first annular spring differs from a biasing rate of the second annular spring.

4. The sealing device according to claim 1, wherein the annular receptacle is configured to be in fluid communication with a pressure source, a pressurized fluid received from the pressure source biasing the annular seals against the radial face.

5. The sealing device according to claim 1, wherein a sealed chamber is formed between the annular seals, the annular receptacle and the common radial face, the sealed chamber configured to be connected to a pressurized air source, whereby a pressure in the sealed chamber is above that of a surrounding of the common radial face outside of the sealed chamber.

6. The sealing device according to claim 1, further comprising at least one annular stopper between the annular seals, the annular stop delimiting a movement of the annular seals in the biasing direction.

7. The sealing device according to claim 6, wherein the at least one annular stopper is a single annular stopper shared by the annular seals.

8. The sealing device according to claim 6, wherein the annular stopper is connected to a wall of the annular receptacle by axial members.

9. The sealing device according to claim 8, wherein each said annular seal forms at least one sliding joint with at least one of the axial members, a direction of the at least one sliding joint generally corresponding to said axial direction, whereby the at least one sliding joint blocks a rotation of the annular seals relative to the annular receptacle.

10. The sealing device according to claim 8, wherein the first annular seal has at least one peripheral bracket outwardly radially oriented for sliding engagement with at least one of the axial members, and further wherein the second annular seal has at least one peripheral bracket inwardly radially oriented for sliding engagement with at least one of the axial members.

11. A gas turbine engine comprising:
a structure;
at least one rotating shaft having a radial face on a seal runner portion thereof, an annular space being defined between the structure and the at least one rotating shaft; and
a sealing device comprising an annular receptacle secured to the structure to block the annular space, the annular receptacle defining an annular axial opening, a first annular seal and a second annular seal radially superposed in the annular receptacle, the first annular seal and the second annular seal being independently movable in a generally axial direction and configured to project from the annular axial opening to sealingly and commonly contact the radial face, and
at least one biasing device for the first annular seal and the second annular seal, the at least one biasing device biasing the annular seals independently from one another against the common radial face.

12. The gas turbine engine according to claim 11, wherein a sealed chamber is formed between the annular seals, the annular receptacle and the common radial face, the sealed chamber connected to a pressurized air source, whereby a pressure in the sealed chamber is above that of annular space outside of the sealed chamber.

13. The gas turbine engine according to claim 11, further comprising at least one annular stopper between the annular seals, the annular stop delimiting a movement of the annular seals in the biasing direction.

14. The gas turbine engine according to claim 13, wherein the at least one annular stopper is a single annular stopper shared by the annular seals.

15. The gas turbine engine according to claim 13, wherein the annular stopper is connected to a wall of the annular receptacle by axial members.

16. The gas turbine engine according to claim 15, wherein each said annular seal forms at least one sliding joint with at least one of the axial members, a direction of the at least one sliding joint generally corresponding to said axial direction, whereby the at least one sliding joint blocks a rotation of the annular seals relative to the annular receptacle.

17. A method for sealing a space between a radial face of a seal runner portion of a shaft and a structure, comprising:
radially superposing a first and a second annular seal in an annular receptacle located in the space;
biasing the first annular seal against the radial face of the seal runner portion; and
biasing the second annular seal against the radial face of the seal runner portion, the biasing of the first annular seal and the second annular seal being independent from one another.

18. The method according to claim 17, wherein biasing the first annular seal comprises biasing the first annular seal with a first spring, and wherein biasing the second annular seal comprises biasing the second annular seal with a second spring.

19. The method according to claim 17, wherein a sealed chamber is formed between the annular seals, the annular receptacle and the radial face of the seal runner portion, and further comprising injecting pressurized air in the sealed chamber.

20. The method according to claim 17, wherein injecting the pressurized air comprises leaking the pressurized air between at least one of the annular seals and the radial face of the seal runner portion.
